(19) United States
(12) Patent Application Publication
(10) Pub. No.: US 2024/0295762 A1
(43) Pub. Date: Sep. 5, 2024

(54) HYBRID PACKAGE CHIP AND OPTICAL TRANSMITTER

(71) Applicant: PICMORE TECHNOLOGY (SUZHOU) LTD., Suzhou (CN)

(72) Inventors: Mengxi JI, Suzhou (CN); Xianyao LI, Suzhou (CN); Yuzhou SUN, Suzhou (CN)

(21) Appl. No.: 18/602,641

(22) Filed: Mar. 12, 2024

Related U.S. Application Data
(63) Continuation of application No. PCT/CN2022/100797, filed on Jun. 23, 2022.

(30) Foreign Application Priority Data
Sep. 18, 2021 (CN) 202122278170.4

(51) Int. Cl. G02F 1/035

(52) U.S. Cl. CPC G02F 1/035; G02F 2201/302; G02F 2201/58; G02F 2202/20

(57) ABSTRACT

A hybrid package chip and an optical transmitter includes a first sub-chip including a first waveguide and at least one first electrode, and a second sub-chip including a second waveguide and at least one second electrode. The first waveguide is optically coupled to the second waveguide. A first electrode of the first sub-chip and a corresponding second electrode of the second sub-chip are electrically connected to one another by means of a first conductive structure, so as to receive a modulation electrical signal. The first sub-chip is configured to receive external input light and output the light by means of the first waveguide. The at least one first electrode modulates the input light so as to output the modulated light. The second waveguide receives a portion of light from the first sub-chip through coupling.

### CROSS-REFERENCE TO RELATED APPLICATION

This application is a continuation of International Patent Application No. PCT/CN2022/100797, filed on Jun. 23, 2022, which claims priority to Chinese Patent Application No. 202122278170.4, filed on Sep. 18, 2021. All of the foregoing applications are incorporated herein by reference in their entireties.

### TECHNICAL FIELD

The present application relates to the field of semiconductor chip technology and more particularly to a hybrid package chip and an optical transmitter.

### BACKGROUND

In an era of rapid development of information technology, integrated optics is increasingly favored in fields including optical interconnection, optical communication, and optical sensing, by virtue of its advantages such as small size, low energy consumption, and large bandwidth. In particular, silicon-based optoelectronic sub-modules (hereinafter referred to as silicon optical modules) are important in high-speed optical communication by virtue of their compatibility with conventional CMOS processes. In order to improve the modulation efficiency and bandwidth of silicon optical modules, a hybrid integrated optoelectronic chip that integrates another material on a silicon optical module has been proposed. Taking lithium niobate thin film as an example, an entire lithium niobate thin film is bonded to a silicon optical wafer; BCB (benzocyclobutene) resin or silicon dioxide is used in between to combine them by means of adhesive forces or intermolecular forces; and the coupling between a lithium niobate waveguide and a silicon optical waveguide is achieved by means of etching the lithium niobate thin film.

However, in actual manufacturing, the above means of combination has complex processes, low yield rates, and poor reliability, which leads to low production efficiency. Therefore, a pressing problem to be addressed by the industry is how to avoid complex and difficult processes, such as bonding, and reduce the difficulty of coupling between a lithium niobate waveguide and a silicon optical waveguide.

### SUMMARY

In view of deficiencies in conventional art, embodiments of the present disclosure provide a hybrid package chip and an optical transmitter. The embodiments reduce the difficulty of coupling between a lithium niobate waveguide and a silicon optical waveguide while also reducing the difficulty of fabrication processes, and, at the same time, effectively improve the integrity of high-speed signals.

Specifically, one embodiment of the present disclosure provides a hybrid package chip, the hybrid package chip including: a first sub-chip including a first waveguide and at least one first electrode; and a second sub-chip including a second waveguide and at least one second electrode. The first waveguide is optically coupled to the second waveguide. A first electrode of the first sub-chip and a corresponding second electrode of the second sub-chip are electrically connected to one another by means of a first conductive structure, so as to receive a modulation electrical signal. The first sub-chip is configured to receive external input light and output the light by means of the first waveguide. The at least one first electrode modulates the input light so as to output modulated light. The second waveguide receives a portion of light from the first sub-chip through coupling. The first sub-chip is a lithium niobate thin film based optoelectronic sub-chip and the second sub-chip is a silicon-based silicon photonic sub-chip.

In one embodiment, the hybrid package chip includes a grating coupler, and the first waveguide and the second waveguide are optically coupled through the grating coupler.

In one embodiment, the grating coupler includes at least a first grating coupler included in the first waveguide, and at least a second grating coupler included in the second waveguide and aligned with the first grating coupler. The second waveguide receives, through the first grating coupler and the second grating coupler, a portion of light from the first sub-chip through coupling.

In one embodiment, the second sub-chip further includes a monitor photodiode for converting an optical signal received from the second grating coupler into an electrical signal and outputting the electrical signal to an external substrate.

In one embodiment, the hybrid package chip further includes a filler layer between the first sub-chip and the second sub-chip, so as to fixedly connect the first sub-chip and the second sub-chip.

In one embodiment, the filler layer covers an area where the first and second grating couplers are located, and an effective refractive index of the filler layer matches an effective refractive index of the first and second grating couplers.

In one embodiment, the first electrode and the first waveguide are disposed side by side, the first electrode modulating light that passes through the first waveguide. The first electrode includes a first input coupling portion and a first output coupling portion. The second electrode includes a second input coupling portion facing the first input coupling portion and aligned with the first input coupling portion, and a second output coupling portion facing the first output coupling portion and aligned with the first output coupling portion. The first input coupling portion and the second input coupling portion are configured to receive the modulation electrical signal, and the first output coupling portion and the second output coupling portion are configured to return the modulation electrical signal to the second sub-chip.

In one embodiment, the second sub-chip further includes a third electrode facing the external substrate and a conductive via extending through the second sub-chip. The third electrode is electrically connected to the external substrate through a second conductive structure. One end of the conductive via is electrically connected to the second conductive structure. Another end of the conductive via is electrically connected to the first conductive structure.

In one embodiment, the second sub-chip is electrically connected to the external substrate through a conductive wire that is electrically connected to the second electrode so as to transmit an electrical signal.

Another embodiment of the present disclosure further provides an optical transmitter, the optical transmitter including any of the hybrid package chips described above.

### BRIEF DESCRIPTION OF DRAWINGS

The following detailed description of specific embodiments of the disclosure, in conjunction with the drawings, will make the technical solutions and other advantageous effects of the present disclosure apparent.

FIG. 1A is a schematic diagram of an optical signal modulation principle of an optoelectronic sub-chip in a hybrid package chip according to a first embodiment of the present disclosure.

FIG. 1B is a schematic diagram of an optical signal modulation principle on one side of a silicon photonic sub-chip in the hybrid package chip according to the first embodiment of the present disclosure.

FIG. 1C is a schematic diagram of an optical signal modulation principle on another side of the silicon photonic sub-chip in the hybrid package chip according to the first embodiment of the present disclosure.

FIG. 2 is a schematic cross-sectional view of an electrical coupling structure between electrodes of a lithium niobate thin film modulator of the hybrid package chip according to the first embodiment of the present disclosure.

FIG. 3 is a schematic cross-sectional view of a grating coupling structure of the hybrid package chip according to the first embodiment of the present disclosure.

FIG. 4 is a top view of an end-face coupling structure of the optoelectronic sub-chip in the hybrid package chip according to the first embodiment of the present disclosure.

FIG. 5 is a schematic cross-sectional view of a hybrid package chip according to a second embodiment of the present disclosure.

### DETAILED DESCRIPTION

A clear and complete description of technical solutions in embodiments of the present disclosure are provided below in conjunction with drawings in the embodiments of the present disclosure. Obviously, the described embodiments are only some and not all embodiments of the present disclosure. All other embodiments obtained by persons of skill in the art based on the embodiments in the present disclosure without creative labor fall within the scope of protection of the present disclosure.

In the specification and claims of the present disclosure and the drawings, the terms “first,” “second,” “third,” etc. (if present) are used to distinguish similar objects and are not necessarily used to describe a particular order or sequence. It should be understood that the objects so described are interchangeable where appropriate. In the description of the present disclosure, “plurality” means two or more, unless otherwise defined expressly and specifically. In addition, the terms “comprise” and “has” and any variations thereof are intended to indicate open-ended inclusion. Some of the block diagrams shown in the drawings are functional entities and do not necessarily have to correspond to physically or logically independent entities. These functional entities may be implemented in a software form, or in one or more hardware circuits or integrated circuits, or in different networks and/or processor devices and/or microcontroller devices.

In the description of the present disclosure, it is noted that, unless otherwise expressly specified and defined, the terms “install,” “connected,” and “connect” are to be understood in a broad sense; for example, it may be a fixed connection, a detachable connection, or an integral connection; it may be a mechanical connection, an electrical connection, or in mutual communication; it may be a direct connection or an indirect connection through an intermediate medium; it may be an internal connect between two components or an interactive relationship between two components. To persons of ordinary skill in the art, the specific meaning of the above terms in the present disclosure may be understood in their specific context.

In order to make the purpose, features, and advantages of the present disclosure more obvious and understandable, the present disclosure is described in further detail below in conjunction with the drawings and embodiments.

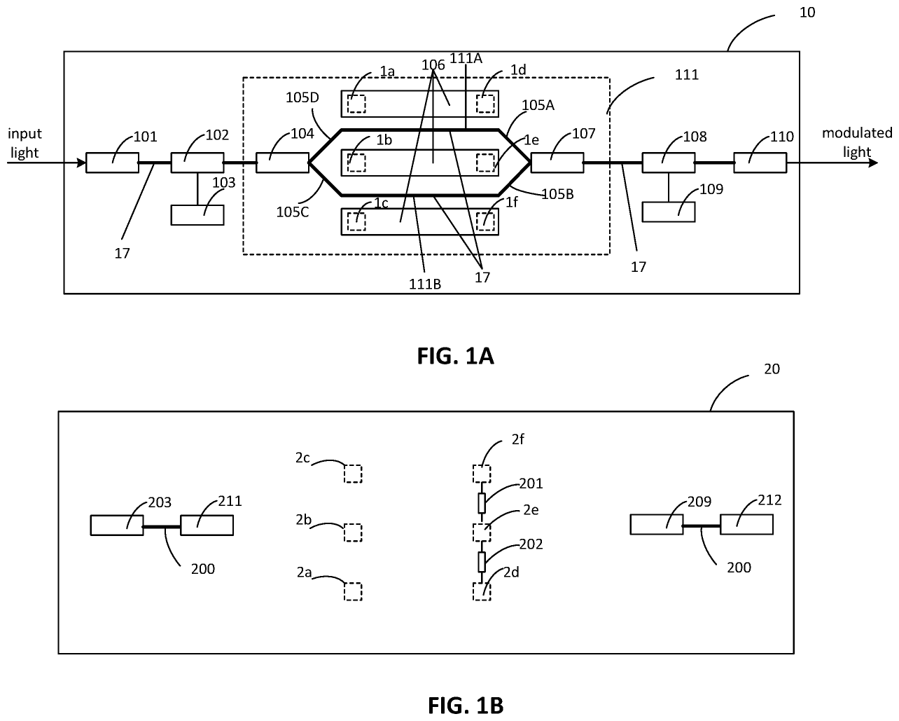

FIG. 1A is a schematic diagram of an optical signal modulation principle of an optoelectronic sub-chip in a hybrid package chip according to a first embodiment of the present disclosure. FIG. 1B is a schematic diagram of an optical signal modulation principle on one side of a silicon photonic sub-chip in the hybrid package chip according to the first embodiment of the present disclosure. FIG. 1C is a schematic diagram of an optical signal modulation principle on another side of the silicon photonic sub-chip in the hybrid package chip according to the first embodiment of the present disclosure. The hybrid package chip according to the first embodiment includes a silicon photonic sub-chip (i.e., a second sub-chip) 20 and an optoelectronic sub-chip (i.e., a first sub-chip) 10 integrated on the silicon photonic sub-chip 20. According to the first embodiment, the main material of the silicon photonic sub-chip 20 is different from the main material of the optoelectronic sub-chip 10. According to an embodiment, the silicon photonic sub-chip 20 is mainly made of a silicon material, while the optoelectronic sub-chip 10 is mainly made of a lithium niobate material, and the optoelectronic sub-chip 10 includes a lithium niobate thin film modulator to modulate an incident optical signal. A description is provided below using an example where the thin-film lithium niobate based optoelectronic sub-chip 10 is integrated on the silicon photonic sub-chip 20.

The optical signal modulation principle of the hybrid package chip according to the first embodiment of the present disclosure is described below in conjunction with FIG. 1A, FIG. 1B, and FIG. 1C.

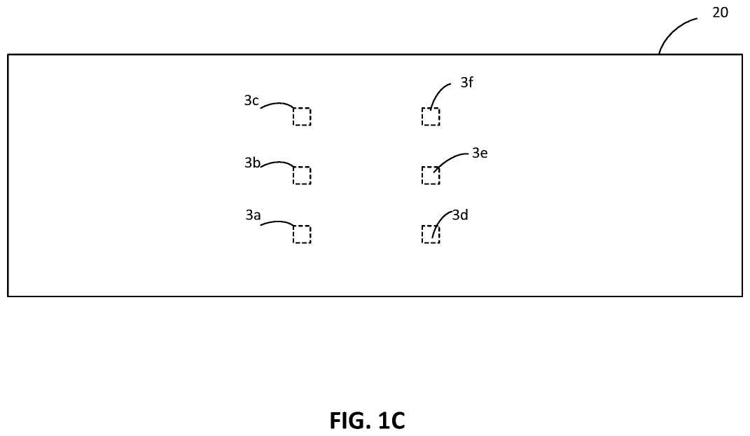

As shown in FIG. 1A, the optoelectronic sub-chip 10 according to the first embodiment of the present disclosure includes a first end-face coupler 101, a first directional coupler 102, a first lithium niobate grating coupler 103, a beam splitter 104, a first waveguide 17 which includes a first lithium niobate grating coupler 103 and a second lithium niobate grating coupler 109 (as indicated by the bold lines labeled “17” in FIG. 1A), a beam combiner 107, a second directional coupler 108, and a second end-face coupler 110. Here, input light from a laser is coupled to an optical fiber array (i.e., a first optical fiber array) and enters into the first waveguide 17 (as illustrated by bold solid lines in FIG. 1A) of a lithium niobate waveguide layer via the first end-face coupler 101 of the thin-film lithium niobate based optoelectronic sub-chip 10. Here, the first waveguide 17 includes two modulation area waveguide sections 111A and 111B, and non-modulation area waveguide sections 105A, 105B, 105C, 105D on two ends of the first waveguide 17. The input light that has entered the first waveguide 17 is evenly split, upon passing through the beam splitter 104, into two beams of light of equal intensity, which enter two arms of a lithium niobate thin film modulator 111 (i.e. the modulation area waveguide sections 111A and 111B). According to the first embodiment, taking a Mach-Zehnder modulator (MZM) as an example, electro-optic modulation is performed on the input light, wherein a modulation electrical signal comes from a substrate 30 (i.e., external substrate 30 shown in FIG. 2). The substrate 30 is used for carrying the silicon photonic sub-chip 20 and optoelectronic sub-chip 10 and for transmitting the modulation electrical signal, which is input from an external device, to the silicon photonic sub-chip 20 through a conductor wire and an electrode. This modulation electrical signal is subsequently transmitted via the silicon photonic sub-chip 20 shown in FIG. 1B to a first electrode 106 of the thin-film lithium niobate based optoelectronic sub-chip 10, so as to form an electric field on the lithium niobate waveguide layer, thereby impacting an effective refractive index of the modulation area waveguide sections 111A and 111B. When the two beams of light pass through the modulation area waveguide sections 111A and 111B, cumulative phase change will result, thereby accomplishing modulation of the input light. A specific description of the means of transmission for the above-mentioned modulation electrical signal is elaborated below in detail in reference to FIG. 2.

According to an embodiment, before passing through the beam splitter 104, the input light is split into two portions by the first directional coupler 102. A portion of the input light having more energy (e.g., 95% of the light) is inputted into the beam splitter 104 and then undergoes further modulation as described above. The other portion of the input light having less energy (e.g., 5% of the light) is coupled to a first silicon optical grating coupler 203 disposed in a second waveguide 200 (as illustrated by bold solid lines in FIG. 1B) on the silicon photonic sub-chip 20 by the first lithium niobate grating coupler 103 disposed in the first waveguide 17, and subsequently enters into a first monitor photodiode (MPD) 211 on the silicon photonic sub-chip 20. The first monitor photodiode 211 converts the portion of the input light to an electrical signal and outputs the electrical signal to the substrate 30 (shown in FIG. 2) to implement monitoring operations, as shown in FIG. 1B. The substrate 30 may be a printed circuit board (PCB), which serves as a carrier for electrical connection between electronic components. Similarly, after the electro-optic modulation completes, modulated optical signals are combined into one beam upon passing through the beam combiner 107. The combined beam enters the second directional coupler 108 and is split into two portions by the second directional coupler 108. A portion of the combined beam having more energy (e.g., 95% of the light) is outputted to an optical fiber array (i.e., a second optical fiber array) through the second end-face coupler 110. The other portion of the combined beam having less energy (e.g., 5% of the light) is coupled to a second silicon optical grating coupler 209 disposed in the second waveguide 200 of the silicon photonic sub-chip 20 by the second lithium niobate grating coupler 109 disposed in the first waveguide 17 of the thin-film lithium niobate based optoelectronic sub-chip 10, and enters a second monitor photodiode 212 on the silicon photonic sub-chip 20. The second monitor photodiode 212 converts a portion of the modulated light to an electrical signal and outputs the electrical signal to the substrate 30 to implement monitoring operations. The electrical signals outputted from the first monitor photodiode 211 and the second monitor photodiode 212 can be used for MZM work point feedback.

FIG. 2 is a schematic cross-sectional view of an electrical coupling structure between electrodes of the lithium niobate thin film modulator of the hybrid package chip according to the first embodiment of the present disclosure. A detailed description is provided below in conjunction with FIGS. 1A, 1B, 1C, and 2.

According to the first embodiment, the thin-film lithium niobate based optoelectronic sub-chip 10 includes, stacked in a top-to-bottom order, a first substrate layer 16 (e.g., a silicon substrate), a first silicon dioxide layer 15, a first covering layer 12, and a lithium niobate waveguide layer 11, the lithium niobate waveguide layer 11 having disposed therein a first electrode 106 (e.g., a ground-signal-ground (GSG) electrode, or possibly a ground-signal-signal-ground (GSSG) electrode or a ground-signal (GS) electrode in other embodiments) and the first waveguide 17, wherein the first electrode 106 includes a signal electrode (S) and two ground electrodes (G). The first waveguide 17 shown in FIG. 2 includes modulation area waveguide sections, i.e., the two modulation arms 111A and 111B in FIG. 1A. The thin-film lithium niobate based optoelectronic sub-chip 10 further includes a first conductive structure electrically connected to the silicon photonic sub-chip 20. The first conductive structure includes first solder pads 14 at an electrical coupling area of the first electrode 106 and first conductive bumps 13 electrically connected to the first solder pads 14. As shown in FIG. 1A, the electrical coupling area includes first input coupling portions 1a, 1b, and 1c located at one end of the first electrode 106, and first output coupling portions 1d, 1e, and 1f located at another end of the first electrode 106. Each of the input coupling portions and each of the output coupling portions has a corresponding solder pad, and each solder pad corresponds to a conductive bump, which is used for electrical connection with other members.

As shown in FIG. 2, the silicon photonic sub-chip 20 includes, stacked in a bottom-to-top order, a second substrate layer 21 (e.g., a silicon substrate), a second silicon dioxide layer 25, a second covering layer 26, and a silicon waveguide layer 27. Second electrodes 2a, 2b, 2c, 2d, 2e, and 2f (shown in FIG. 1B) are disposed in the silicon waveguide layer 27. Referring to FIGS. 1A and 1B again, the second electrodes 2a, 2b, 2c, 2d, 2e, and 2f (shown in FIG. 1B) include second input coupling portions 2a, 2b, and 2c facing the first input coupling portions 1a, 1b, and 1c (shown in FIG. 1A) and aligned with the first input coupling portions 1a, 1b, and 1c, respectively, and second output coupling portions 2d, 2e, and 2f facing the first output coupling portions 1d, 1e, and 1f (shown in FIG. 1A) and aligned with the first output coupling portions 1d, 1e, and 1f, respectively. The first input coupling portions 1a, 1b, and 1c and the second input coupling portions 2a, 2b, and 2c are used for receiving the modulation electrical signal inputted to the thin-film lithium niobate based optoelectronic sub-chip 10, and the first output coupling portions 1d, 1e, and 1f and the second output coupling portions 2d, 2e, and 2f are used for returning the modulation electrical signal to the silicon photonic sub-chip 20 so as to form a loop. According to an embodiment, the second input coupling portions 2a, 2b, and 2c and the second output coupling portions 2d, 2e, and 2f of the second electrodes include second solder pads 24 (shown in FIG. 2) corresponding to the first conductive bumps 13, and the second solder pads 24 are electrically connected to the first conductive bumps 13. Additionally, as shown in FIG. 1B, the silicon photonic sub-chip 20 further includes terminal matching resistors 201 and 202 connected in series to the second output coupling portions 2d, 2e, and 2f.

As shown in FIG. 1C, the silicon photonic sub-chip 20 further includes third electrodes 3a, 3b, 3c, 3d, 3e, and 3f disposed on a backside of the second substrate layer 21 facing the substrate 30. Here, the third electrodes 3a, 3b, 3c, 3d, 3e, and 3f include third input coupling portions 3a, 3b, and 3c and third output coupling portions 3d, 3e, and 3f. The third input coupling portions 3a, 3b, and 3c are used for receiving the modulation electrical signal inputted to the silicon photonic sub-chip 20, and the third output coupling portions 3d, 3e, and 3f are used for outputting the modulation electrical signal to the substrate 30. As shown in FIG. 2, the silicon photonic sub-chip 20 further includes conductive vias 22 extending through the silicon photonic sub-chip 20. The third electrodes 3a, 3b, 3c, 3d, 3e, and 3f are electrically connected to the external substrate 30 through a second conductive structure. The second conductive structure includes third solder pads 34 respectively located at the third input coupling portions 3a, 3b, and 3c and the third output coupling portions 3d, 3e, and 3f, and second conductive bumps 23 electrically connected to the third solder pads 34. One end of each one of the conductive vias 22 is electrically connected to the second conductive structure, another end of each one of the conductive vias 22 is electrically connected to the first conductive structure. Here, the second solder pads 24 and the third solder pads 34 disposed on the silicon photonic sub-chip 20 are respectively electrically connected to the conductive vias 22. According to an embodiment, the third input coupling portions 3a, 3b, and 3c and the third output coupling portions 3d, 3e, and 3f of the third electrodes are the third solder pads 34 electrically connected to the second conductive bumps 23. Although FIG. 2 illustratively shows a relationship of locations of the second solder pads 24 and the third solder pads 34 relative to locations of the conductive vias 22, it should be understood that the conductive vias 22 do not necessarily align with the second solder pads 24 and the third solder pads 34.

According to an embodiment, the conductive vias 22 may be made with a TSV (through silicon via) process. The conductive vias 22 are filled with a conductive material, such as copper or another metal. The TSVs run through the silicon photonic sub-chip 20, thereby electrically connecting the silicon photonic sub-chip 20 to the substrate 30 and the thin-film lithium niobate based optoelectronic sub-chip 10 and allowing a higher chip stacking density.

Additionally, the first conductive bumps 13 and the second conductive bumps 23 may be copper pillar bumps, or bumps made in top-layer metal solder pad openings. Embodiments of the present disclosure do not impose any limitation in this respect.

According to the first embodiment, as shown in FIG. 2, the hybrid package chip further includes a first filler layer 32 located between the thin-film lithium niobate based optoelectronic sub-chip 10 and the silicon photonic sub-chip 20 and a second filler layer 31 located between the silicon photonic sub-chip 20 and the substrate 30, so as to fix stacked modules. The first filler layer 32 has disposed therein the first conductive bumps 13. The second filler layer 31 has disposed therein the second conductive bumps 23. According to an embodiment, the first filler layer 32 does not cover an area where the grating couplers are located. Alternatively, accordingly to another embodiment, the first filler layer 32 covers the area where the grating couplers are located, and the effective refractive index of the first filler layer 32 matches the effective refractive index of the grating couplers.

According to the first embodiment, the first electrode 106 (e.g., the GSG electrode) on the thin-film lithium niobate based optoelectronic sub-chip 10 is electrically connected to the silicon photonic sub-chip 20 through first conductive bumps 13, and the silicon photonic sub-chip 20 is electrically connected to the substrate 30 through the second conductive bumps 23. Therefore, the modulation electrical signal used for the electro-optic modulation first enters the silicon photonic sub-chip 20 from the substrate 30 through the second conductive bumps 23, and then flows into an input electrical coupling area of the first electrode 106 of the thin-film lithium niobate based optoelectronic sub-chip 10 through the conductive vias 22 of the silicon photonic sub-chip 20 and the first conductive bumps 13, so as to drive electro-optic modulation. Finally, the modulation electrical signal returns into the silicon photonic sub-chip 20 through an output electrical coupling area of the thin-film lithium niobate based optoelectronic sub-chip 10, and is then terminated by the terminal matching resistors 201 and 202 on the silicon photonic sub-chip 20.

According to the first embodiment, the thin-film lithium niobate based optoelectronic sub-chip 10 is electrically connected to the silicon photonic sub-chip 20 by means of flip chip packaging. Specifically, the first solder pads 14 are made on a frontside electrical coupling area of the thin-film lithium niobate based optoelectronic sub-chip 10, which is electrically connected, through the first conductive bumps 13 disposed on the first solder pads 14, to the second solder pads 24 on a frontside electrical coupling area of the silicon photonic sub-chip 20, thereby realizing non-bonding integration between the thin-film lithium niobate based optoelectronic sub-chip 10 and the silicon photonic sub-chip 20. Additionally, by making vertical vias between modules using a TSV packaging technology, electrical interconnection between the sub-chips 10 and 20 and the substrate 30 can be realized, and the impact of electromagnetic interference on the bandwidth is mitigated, ensuring signal integrity of the hybrid integrated optoelectronic chip.

It should be understood that FIGS. 1A, 1B, 1C, and 2 only show portions of the hybrid package chip. A complete hybrid integrated optoelectronic chip may also integrate other waveguides and electrodes, as well as other active and passive components.

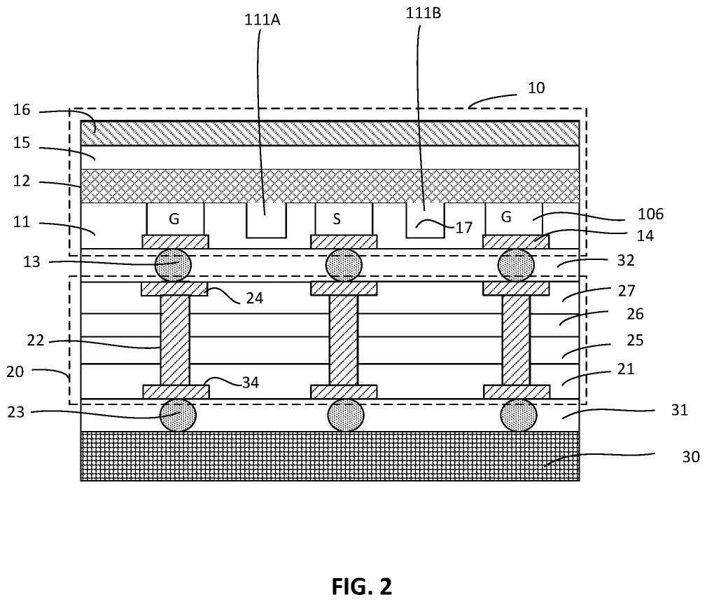

FIG. 3 is a schematic cross-sectional view of a grating coupling structure of the hybrid package chip according to the first embodiment of the present disclosure. The grating coupling structure includes a first grating coupling structure composed of the first lithium niobate grating coupler 103 and the first silicon optical grating coupler 203, and/or a second grating coupling structure composed of the second lithium niobate grating coupler 109 and the second silicon optical grating coupler 209, shown in FIGS. 1A and 1B.

As shown in FIG. 3, taking the second grating coupling structure composed of the second lithium niobate grating coupler 109 and the second silicon optical grating coupler 209 as an example, the thin-film lithium niobate based optoelectronic sub-chip 10 includes, stacked in a top-to-bottom order, the first substrate layer 16 (e.g., a silicon substrate), the first silicon dioxide layer 15, the first covering layer 12, and the lithium niobate waveguide layer 11. The first waveguide 17 is disposed in the lithium niobate waveguide layer 11. Here, the first waveguide 17 is a non-modulation area waveguide section, and the first waveguide 17 includes the second lithium niobate grating coupler 109. Correspondingly, the silicon photonic sub-chip 20 includes, stacked in a bottom-to-top order, the second substrate layer 21, the second silicon dioxide layer 25, the second covering layer 26, and the silicon waveguide layer 27. The second waveguide 200 (shown in FIG. 1B) is disposed in the silicon waveguide layer 27, and the second waveguide 200 includes the second silicon optical grating coupler 209. According to an embodiment, outside of the area where the grating couplers are located, the hybrid package chip further includes the first filler layer 32 between the thin-film lithium niobate based optoelectronic sub-chip 10 and the silicon photonic sub-chip 20. Alternatively, according to another embodiment, the first filler layer 32 covers the area where the grating couplers are located, and the effective refractive index of the first filler layer 32 matches the effective refractive index of the grating couplers.

According to the first embodiment, since the grating coupling structure composed of the second lithium niobate grating coupler 109 and the second silicon optical grating coupler 209 is used only for optical coupling of the MPD, coupling efficiency is subject to lower requirements. At the same time, the grating coupling structure is able to enlarge an originally small mode spot in the waveguide to a large mode spot by means of optical diffraction, thereby realizing optical fiber mode matching and making coupling more convenient. Meanwhile, as the mode spot is enlarged, alignment precision is subject to lower requirements, thus reducing the difficulty for coupling.

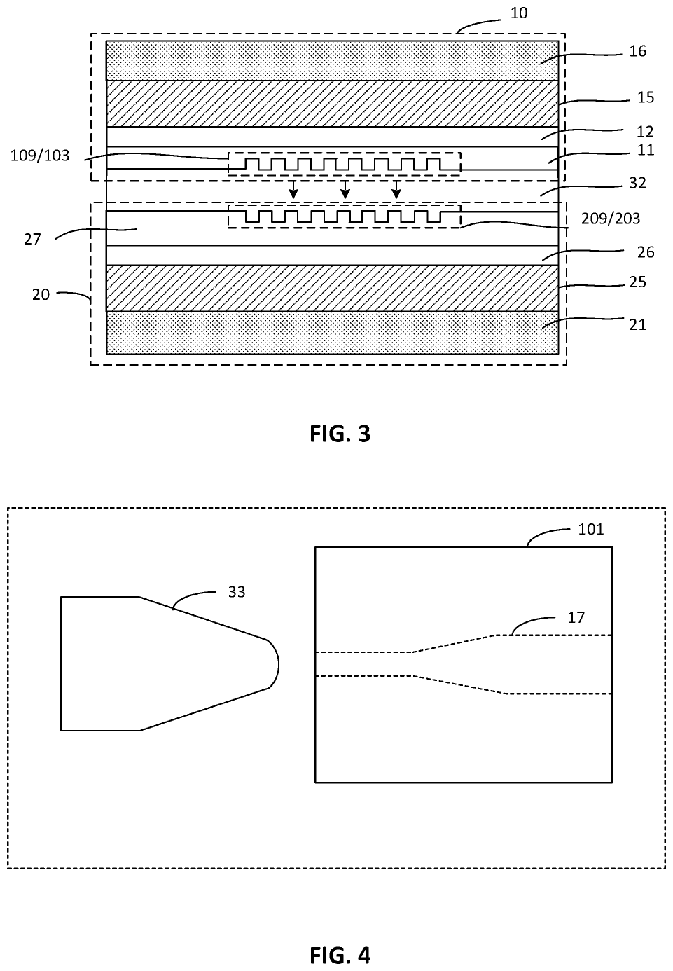

FIG. 4 is a top view of an end-face coupling structure of the optoelectronic sub-chip 10 in the hybrid package chip according to the first embodiment of the present disclosure. The end-face coupling structure is the first end-face coupler 101 and/or the second end-face coupler 110 shown in FIG. 1A, and both inputting of light to be modulated and outputting of a modulated optical signal are realized by means of coupling between the first or second end-face coupler and an optical fiber array (first or second optical fiber array). The coupling efficiency is relatively high, which can reduce losses along the entire optical path. A detailed description is provided below, using only the first end-face coupler 101 as an example, in conjunction with FIGS. 1A through 3.

The first end-face coupler 101 includes the first waveguide 17 located in the lithium niobate waveguide layer 11, and the first silicon dioxide layer 15 and the first substrate layer 16 located above the lithium niobate waveguide layer 11 (as shown in FIG. 2). The first waveguide 17 has a section that is a tapered waveguide, and couples to an external optic fiber 33 through this tapered waveguide, thereby gradually transitioning an optical mode into the first waveguide 17. By means of coupling between the optical fiber array and the lithium niobate waveguide end-face, inputting and outputting of a main light source can be realized, and optical path losses can be reduced.

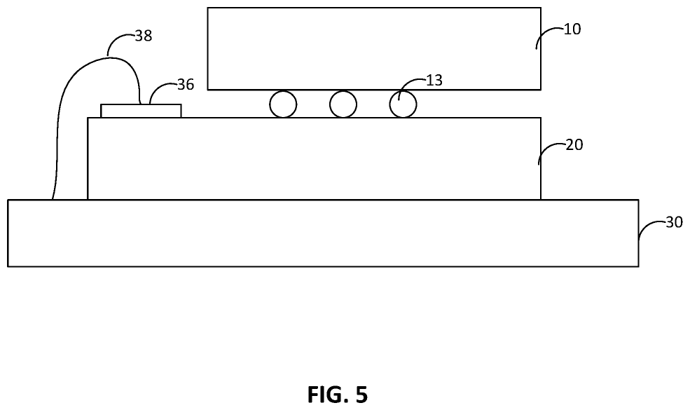

FIG. 5 is a schematic cross-sectional view of a hybrid package chip according to a second embodiment of the present disclosure. The second embodiment differs from the first embodiment in that the conductive vias in the first embodiment are replaced by wire solder pads disposed on the silicon photonic sub-chip. According to the second embodiment, the hybrid package chip includes, stacked in a bottom-to-top order, the silicon photonic sub-chip 20, a wire solder pad 36 disposed on a surface of the silicon photonic sub-chip 20 and electrically connected to a second electrode (not shown in the figure) of the silicon photonic sub-chip 20, conductive bumps 13 disposed at a surface of the silicon photonic sub-chip 20, and the thin-film lithium niobate based optoelectronic sub-chip 10 electrically connected to the silicon photonic sub-chip 20 through the conductive bumps 13. In the second embodiment, the wire solder pad 36 is electrically connected to the substrate 30 by a conductive wire 38, e.g., a gold wire, so as to transmit an electrical signal. It should be understood that the second electrode may include an electrode aligned with a modulating electrode (e.g., a GSG electrode) that forms an electric field on a first waveguide of the thin-film lithium niobate based optoelectronic sub-chip 10, and it may also include another electrode used for electrical connection with an external power source.

The structure of the hybrid integrated optoelectronic chip shown above in the second embodiment improves the means by which the silicon photonic sub-chip and the thin-film lithium niobate based optoelectronic sub-chip are integrated by using a non-bonding means, and enables electrical connection through the conductive bumps between the two sub-chips, so as to reduce the difficulty of the manufacturing process.

The present disclosure further discloses an optical transmitter, the optical transmitter including any of the hybrid package chips described above.

The hybrid package chip and the optical transmitter provided by embodiments of the present disclosure improve, by using a non-bonding means, the means for integrating a silicon photonic sub-chip and a thin-film lithium niobate based optoelectronic sub-chip. By means of non-bonding conductive bumps, the difficulty of the processes for manufacturing the chips and the difficulty of coupling between a lithium niobate waveguide and a silicon optical waveguide are reduced. At the same time, in a further embodiment, a structure in which a conductive bump and a conductive via work in coordination is able to avoid electromagnetic radiation interference caused by the conventional means of gold wiring, thereby ensuring signal integrity of the hybrid integrated optoelectronic chip.

By using a non-bonding means, embodiments of the present disclosure improve the means for integrating a silicon photonic sub-chip and a thin-film lithium niobate based optoelectronic sub-chip, thereby reducing the difficulty of coupling between a lithium niobate waveguide and a silicon optical waveguide while reducing the difficulty of the fabrication process.

The hybrid package chip and optical transmitter provided by embodiments of the present disclosure are described in detail above, and specific examples are used herein to explain the principles and implementation of the present disclosure. The description of the above embodiments is only used to assist in the understanding of the technical solutions and core ideas of the present disclosure. Persons of ordinary skill in the art should understand that it is still possible for them to modify the technical solutions documented in the above embodiments or to make equivalent substitutions for some of the technical features therein. However, these modifications or substitutions do not cause the essence of the corresponding technical solutions to depart from the scope of the technical solutions of embodiments of the present disclosure.

1. An hybrid package chip, comprising:
a first sub-chip including a first waveguide and at least one first electrode; and
a second sub-chip including a second waveguide and at least one second electrode,
wherein the first waveguide is optically coupled to the second waveguide,
a first electrode of the first sub-chip and a corresponding second electrode of the second sub-chip are electrically connected to one another by means of a first conductive structure, so as to receive a modulation electrical signal,
the first sub-chip is configured to receive external input light and output the light by means of the first waveguide, the at least one first electrode modulates the input light so as to output the modulated light, and the second waveguide receives a portion of light from the first sub-chip through coupling, and
the first sub-chip is a lithium niobate thin film based optoelectronic sub-chip, and the second sub-chip is a silicon-based silicon photonic sub-chip.

2. The hybrid package chip according to claim 1, further comprising a grating coupler, wherein the first waveguide and the second waveguide are optically coupled through the grating coupler.

3. The hybrid package chip according to claim 2, wherein the grating coupler includes at least a first grating coupler included in the first waveguide, and at least a second grating coupler included in the second waveguide and aligned with the first grating coupler, and
the second waveguide receives, through the first grating coupler and the second grating coupler, a portion of light from the first sub-chip through coupling.

4. The hybrid package chip according to claim 3, wherein the second sub-chip further comprises a monitor photodiode for converting an optical signal received from the second grating coupler into an electrical signal and outputting the electrical signal to an external substrate.

5. The hybrid package chip according to claim 1, further comprising a filler layer between the first sub-chip and the second sub-chip, so as to fixedly connect the first sub-chip and the second sub-chip.

6. The hybrid package chip according to claim 5, further comprising a grating coupler, wherein the filler layer covers an area where the grating coupler is located, and an effective refractive index of the filler layer matches an effective refractive index of the grating coupler.

7. The hybrid package chip according to claim 5, wherein
the first electrode and the first waveguide are disposed side by side, the first electrode modulating light that passes through the first waveguide,
the first electrode comprises a first input coupling portion and a first output coupling portion,
the second electrode comprises a second input coupling portion facing the first input coupling portion and aligned with the first input coupling portion, and a second output coupling portion facing the first output coupling portion and aligned with the first output coupling portion, and
the first input coupling portion and the second input coupling portion are configured to receive the modulation electrical signal, and the first output coupling portion and the second output coupling portion are configured to return the modulation electrical signal to the second sub-chip.

8. The hybrid package chip according to claim 7, wherein the second sub-chip further comprises a third electrode facing an external substrate and a conductive via extending through the second sub-chip, the third electrode is electrically connected to the external substrate through a second conductive structure, one end of the conductive via is electrically connected to the second conductive structure, another end of the conductive via is electrically connected to the first conductive structure.

9. The hybrid package chip according to claim 5, wherein the second sub-chip is electrically connected to an external substrate through a conductive wire that is electrically connected to the second electrode so as to transmit an electrical signal.

10. An optical transmitter, comprising the hybrid package chip according to claim 1.
